(19) United States
(12) Patent Application Publication
(10) Pub. No.: US 2023/0046013 A1
(43) Pub. Date: Feb. 16, 2023

(54) Phone Holder

(71) Applicants: Annette Brooks Lane, Murfreesboro, TN (US); Angela B. Walker, Milledgeville, GA (US)

(72) Inventors: Annette Brooks Lane, Murfreesboro, TN (US); Angela B. Walker, Milledgeville, GA (US)

(21) Appl. No.: 17/872,177

(22) Filed: Jul. 25, 2022

Related U.S. Application Data
(60) Provisional application No. 63/233,389, filed on Aug. 16, 2021.

(51) Int. Cl. H04B 1/3888; H04M 1/72409; H04M 1/04

(52) U.S. Cl. CPC H04B 1/3888; H04M 1/724092; H04M 1/724094; H04M 1/04; H04M 2201/08

(57) ABSTRACT

A phone holder includes a pocket having a rear wall and a front wall and configured to receive a phone; an elongate neck extending from an upper portion of the rear wall of the pocket and foldable relative to the rear wall of the pocket; and at least one magnet located on or in the neck. The neck is foldable so that a rear surface of the neck faces an opposite surface of the rear wall to enable the neck to overlie a waist band of clothing of the user or a belt or the like with the magnet being magnetically coupled by magnetic attraction to the phone at a location adjacent the phone to support the phone holder.

### FIELD

The present disclosure relates to phone holders. More particularly, the disclosure relates to an improved phone holder that is of uncomplicated configuration that is easy to install and uninstall without requiring the user to have a belt, requires no tools, enables the phone screen to be visible to the user and to enable user interaction with the touch screen features of the phone while in the holder.

### BACKGROUND

Improvement is desired in the provision of devices for maintaining a cellular phone proximate a user. Conventional devices have many shortcomings. The majority require the user to wear a belt. The present disclosure advantageously provides a phone holder that offers many advantages and overcomes many shortcomings of conventional phone holding devices.

### SUMMARY

The present disclosure provides a phone holder configured to be easy to install and uninstall, requires no tools and can be used without the user wearing a belt, enables the phone screen to be visible to the user and to enable user interaction with the touch screen features of the phone while in the holder.

In one aspect, a phone holder according to the disclosure includes a pocket having a rear wall and a front wall, the pocket configured to receive a phone, with the pocket having an enclosed bottom and opposite sidewalls with an open top through which the phone is receivable into the pocket; an elongate neck extending from an upper portion of the rear wall of the pocket and foldable relative to the rear wall of the pocket; and at least one magnet located on or in the neck.

The neck is foldable so that a rear surface of the neck is positionable to face an opposite surface of the rear wall to enable the neck to overlie a waist band of clothing of the user or a belt of the user, with the magnet being magnetically couplable by magnetic attraction to the phone received in the pocket at a location adjacent the phone to support the phone holder.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 shows a phone holder according to the disclosure.

FIG. 2 shows details of structures used to provide the phone holder.

FIG. 3 shows the phone holder as used for application to a waist band of a user.

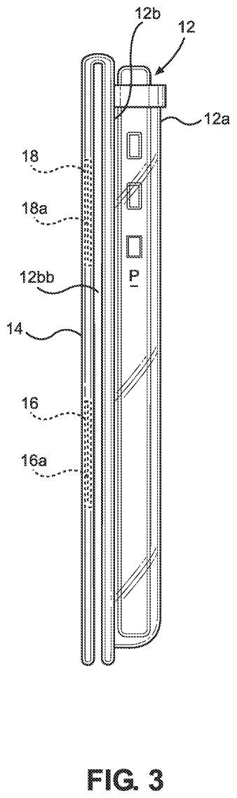

### DETAILED DESCRIPTION

With reference to the drawings, there is shown a flexible phone holder 10 according to the disclosure. The phone holder 10 includes a pocket 12 configured to securely receive a cellular phone P having a touch screen S. The pocket 12 is deep enough to wholly receive the phone P and is dimensioned to snugly engage the phone P to resist the phone P falling out of the pocket 12 or the like when the user ambulates or bends over or otherwise moves about.

The phone holder 10 is advantageously configured to be easy to install and uninstall, requires no tools, enables the phone screen S to be visible to the user and to enable user interaction with the touch screen features of the phone P while in the holder 10.

The pocket 12 includes a front wall 12a and a rear wall 12b. The front wall 12a is transparent and provides a cover piece that enables a user to interface with the touch screen S of the phone P through the front wall 12a. A thin, clear flexible vinyl material may be used for the front wall 12a as it is transparent, enables tactile interfacing with the touch screen S, and offers water resistance. The rear wall 12b has an opposite surface 12bb that faces away from the rear wall 12b.

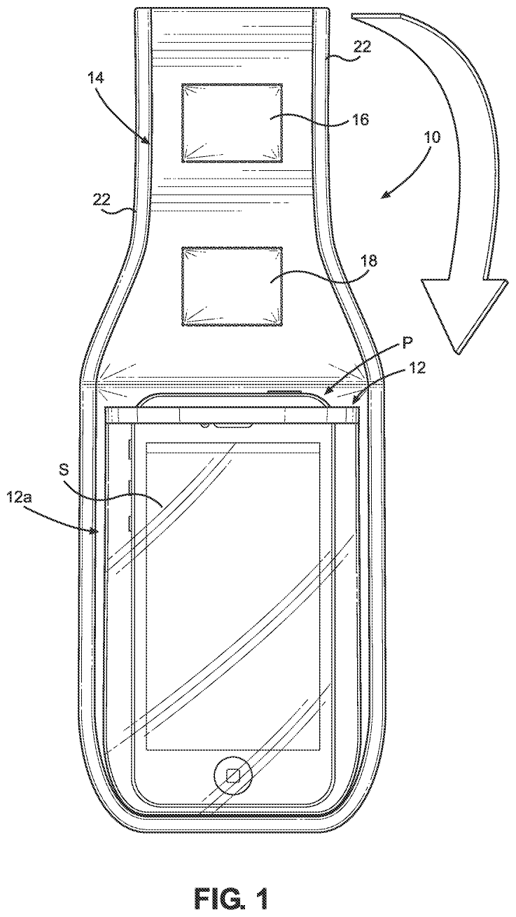

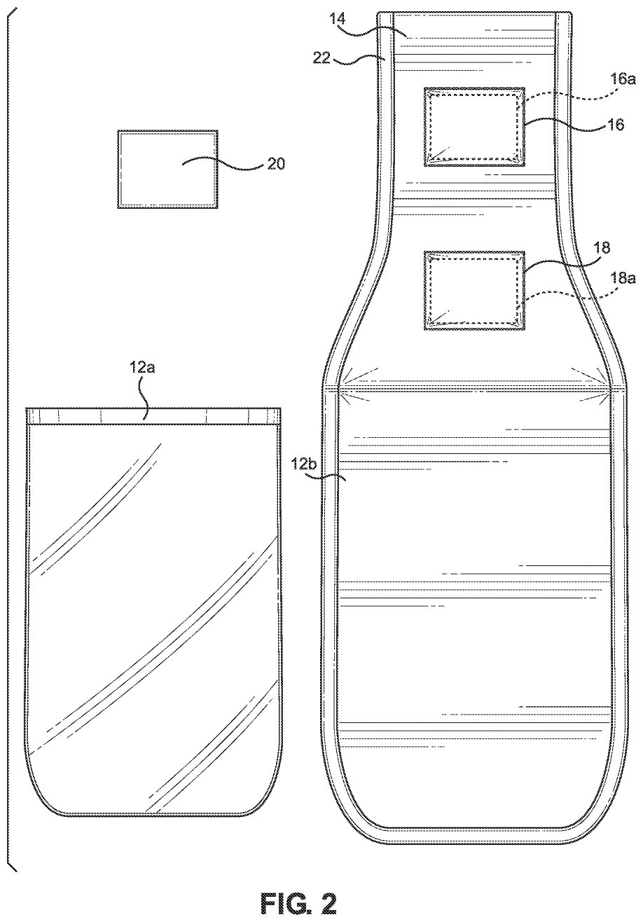

The holder 10 includes an elongate neck 14 that extends from an upper portion of the rear wall 12b of the pocket 12 and is foldable relative to the rear wall 12b of the pocket as represented by the arrow in FIG. 1. The neck 14 has (from the vantage of FIG. 2) a front surface 14a and a rear surface 14b.

In use of the holder 10 by a user, the neck 14 is folded so that the rear surface 14b faces the opposite surface 12bb of the rear wall 12b. This enables the neck 14 to be oriented to overlie a waist band of clothing of the user so that the waist band supports the holder 10. The holder 10 may also be installed over a belt if desired.

The neck 14 includes a pair of spaced apart magnet pockets 16 and 18 configured according to a magnet stitching guide 20. The magnet pocket 16 includes at least one magnet 16a and the magnet pocket 18 includes at least one magnet 18a. The magnets 16a and 18a are configured so that when the neck 14 so that the rear surface 14b faces the surface 12bb of the rear wall 12b, the magnets 16a and 18a are oriented to magnetically attract to rear surfaces of the phone P. As described below, the magnets 16a and 18a are selected to provide firm retention of the holder 10 yet enable convenient removal.

The rear wall 12b of the pocket 12 and the neck 14 may be made from a one-piece fabric, vinyl, or like sheet material, preferably cut to a shape resembling a long-necked bottle as shown. As described in more detail below, to provide a desired thickness to the neck 14 and the rear wall 12b for structural rigidity of the pocket 12 and to facilitate incorporation of the magnets 16a and 18a, the rear wall 12b and the pocket 14 are formed from two identical pieces of material stitched together. Binding 22 as may be provided by binding tape is desirably applied to provide smooth exterior surfaces to the holder 10.

As previously noted, the phone holder 10 is advantageously configured to be easy to install and uninstall such as on a belt or waist band of a user, requires no tools, enables the phone screen S to be visible to the user and to enable tactile user interaction with the touch screen features of the phone P while in the holder 10.

The holder 10 may be constructed for an average size cellular phone P from the materials and instructions set forth below in Table 1. It will be appreciated that the holder 10 may be custom configured for any specific phone P and that other materials and methodologies may be utilized to provide the structure of the phone holder 10.

TABLE 1
Materials and Step-By-Step Instructions:

Materials needed: 44-45” fabric: ½ yard; Thread; Clear vinyl: ¼ yard;
¼ inch bias binding tape: ¼ yard; ½ inch bias binding tape: 1 yard;
3 1-inch round neodymium round household magnets (12-pound pull),
Instructions:
Cut two holder pieces from the fabric, with the grain of the fabric. Center
any design on the front and/or back of the holder piece before cutting.
Cut one cover piece from the clear vinyl.
Cut out one magnet stitching guide from the pattern and save for later.
Bind the top edge of the clear vinyl with the 14 inch binding. Use a
zigzag stitch.
Place the wrong sides of the holder pieces together and lay the clear
vinyl over the bottom of the 2 holder pieces, using the dotted line on the
pattern as a guide.
Bind the sides and bottom of the holder and clear vinyl pieces together,
leaving the top open to insert the magnets into the pockets.
Use the magnet stitching guide and the lines indicated on the pattern to
stitch the bottom and sides of the magnet pocket closest to the vinyl cover.
Insert one neodymium magnet into the pocket, making sure the “sticky”
side of the magnet is facing down, toward the back of the holder. Use a
thin sheet of metal beneath the holder to attract the magnet while stitching
the remaining side of the first pocket with a zipper foot. Use caution not to
stitch over the sheet of metal.
Repeat steps above for the second magnet pocket, but preferably insert
two magnets into this pocket for extra magnetic attraction. (Magnets
should be stuck together in this pocket.) Ensure the magnets are facing
down toward the back of the holder.
When both magnet pockets are complete, bind the top of the carrier with
either more 12 inch bias binding, or use a binding stitch to close.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A phone holder, comprising:
a pocket having a rear wall and a front wall, the pocket configured to receive a phone, with the pocket having an enclosed bottom and opposite sidewalls with an open top through which the phone is receivable into the pocket;
an elongate neck extending from an upper portion of the rear wall of the pocket and foldable relative to the rear wall of the pocket; and
at least one magnet located on or in the neck;
wherein the neck is foldable so that a rear surface of the neck is positionable to face an opposite surface of the rear wall to enable the neck to overlie a waist band of clothing of the user or a belt of the user, with the magnet being magnetically couplable by magnetic attraction to the phone received in the pocket at a location adjacent the phone to support the phone holder.

2. The phone holder of claim 1, with the front wall of the pocket is transparent.

3. The phone holder of claim 1, wherein the phone has a touch screen and the front wall of the pocket is configured to enable a user to tactilely interface with the touch screen through the front wall of the pocket.

4. A phone holder system, comprising:
a phone having a magnetically attractive rear surface:
a pocket having a rear wall and a front wall, the pocket configured to receive the phone with the rear surface of the phone facing the rear wall of the pocket, the pocket having an enclosed bottom and opposite sidewalls with an open top through which the phone is received into the pocket;
an elongate neck extending from an upper portion of the rear wall of the pocket and foldable relative to the rear wall of the pocket; and
at least one magnet located on or in the neck;
wherein the neck is foldable so that a rear surface of the neck is positionable to face an opposite surface of the rear wall to enable the neck to overlie a waist band of clothing of the user or a belt of the user, with the magnet being magnetically couplable by magnetic attraction to the magnetically attractive rear surface of the phone received in the pocket to support the phone holder.

5. The system of claim 4, with the front wall of the pocket is transparent.

6. The system of claim 4, wherein the phone has a touch screen and the front wall of the pocket is configured to enable a user to tactilely interface with the touch screen through the front wall of the pocket.
